(19) United States
(12) Patent Application Publication
(10) Pub. No.: US 2024/0419794 A1
(43) Pub. Date: Dec. 19, 2024

(54) IDENTIFYING VULNERABILITIES ACROSS SOFTWARE CODE REPOSITORIES

(71) Applicant: Dell Products L.P., Round Rock, TX (US)

(72) Inventors: Girish Murthy, Bangalore (IN); Venkata Nagendra Purushotham Musti, Hyderabad (IN); Dhilip S. Kumar, Bangalore (IN); Shishir Kumar Parhi, Bangalore (IN); Sambasivarao Gaddam, South Grafton, MA (US); Abhishek Jaiswal, Gorakhpur (IN); Ashwin Kumar Reddy Kantam, Hyderabad (IN); Anusha Shetty, Bangalore (IN)

(21) Appl. No.: 18/336,660

(22) Filed: Jun. 16, 2023

(51) Int. Cl. G06F 21/56; G06F 8/71; G06F 21/55; G06F 21/57

(52) U.S. Cl. CPC G06F 21/563; G06F 8/71; G06F 21/552; G06F 21/577; G06F 2221/033

(57) ABSTRACT

Methods, apparatus, and processor-readable storage media for identifying vulnerabilities across software code repositories are provided herein. An example computer-implemented method includes maintaining at least one database associated with a plurality of code repositories; in response to detecting a build process associated with a first code repository of the plurality of code repositories, extracting and storing metadata related to the first code repository in the at least one database; identifying at least one vulnerability associated with the first code repository of the plurality of code repositories; determining whether an additional code repository of the plurality of code repositories is impacted by the at least one vulnerability based at least in part on the metadata stored in the at least one database for the additional code repository; and initiating one or more automated actions to at least partially remediate the at least one vulnerability in the additional code repository.

### BACKGROUND

A software vulnerability (or a software defect) is a weakness in the design, implementation, and/or operation of a software system that could be exploited to cause unintended or unanticipated behavior. Vulnerabilities are typically introduced into software through poor design or coding errors and can be exploited to gain unauthorized access to a system, steal data, and/or disrupt operations.

### SUMMARY

Illustrative embodiments of the disclosure provide techniques for identifying vulnerabilities across software code repositories. An exemplary computer-implemented method includes maintaining at least one database associated with a plurality of code repositories. In response to detecting a build process associated with a first code repository of the plurality of code repositories, metadata related to the first code repository can be extracted and stored in the at least one database. The method may also include identifying at least one vulnerability associated with the first code repository of the plurality of code repositories, and determining whether at least one additional code repository of the plurality of code repositories is impacted by the at least one vulnerability based at least in part on the metadata stored in the at least one database for the at least one additional code repository. One or more automated actions can be initiated to at least partially remediate the at least one vulnerability in the at least one additional code repository.

Illustrative embodiments can provide significant advantages relative to conventional techniques. For example, technical problems associated with identifying software vulnerabilities are mitigated in one or more embodiments by proactively detecting and/or automatically remediating one or more software vulnerabilities across multiple code repositories in an efficient manner.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for identifying vulnerabilities across software code repositories in an illustrative embodiment.

FIG. 2 shows an example of a system architecture in accordance with an illustrative embodiment.

FIG. 3 is a flow diagram illustrating a vulnerability identification process that may be used in connection with an embodiment of the techniques herein.

FIG. 4 is a flow diagram illustrating another vulnerability identification process that may be used in connection with an embodiment of the techniques herein.

FIG. 5 is a flow diagram illustrating a process for identifying vulnerabilities across software code repositories that may be used in connection with an embodiment of the techniques herein.

FIGS. 6 and 7 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Software applications often utilize external libraries provided by third parties. This can be efficient and save time, but it can also introduce vulnerabilities. Conventional techniques can periodically check such libraries for vulnerabilities (e.g., using static, dynamic, and/or manual code analysis techniques), and the software code can then be updated based on the results. In some instances, vulnerability scanning and reporting tools are integrated into build pipelines and/or integrated development environments (IDE), that utilize a global database of vulnerability information (e.g., a national vulnerability database (NVD)). Such techniques typically operate in a reactive mode and are applied to applications that are actively being developed and deployed.

Conventional techniques for identifying and mitigating one or more vulnerabilities generally include performing one or more vulnerability scans on a codebase (or code repository) in response to a build pipeline being executed. The term “build pipeline” in this context and elsewhere herein is intended to be broadly construed so as to encompass a set of tools and/or automated processes used to compile, build, and/or deploy software code.

The vulnerability scans are run against the codebase and dependent libraries of the codebase to report any identified vulnerabilities and any action that needs to be taken (e.g., to use a new version number of a dependent library), and one or more software developers associated with the codebase may be notified. The software developers may analyze the report and can implement one or more mitigation actions (e.g., changing the library version to a newer version and/or making one or more changes to the source code). The build pipeline may be executed again to ensure that identified issues have been fixed, and one or more test cases can also be executed on the codebase. Depending on the results of the test cases, the application can then be executed and deployed to a production environment, for example.

The above process is often time consuming as build cycles are executed multiple times for each application being deployed. If two code repositories share a similar vulnerability, then both code repositories can be scanned in order to identify the vulnerability. Also, the vulnerability scans are performed reactively (e.g., in response to a new build), and therefore, one or more vulnerabilities may not be detected in a timely manner, particularly when the application is not being actively developed. Such vulnerabilities can be present across multiple software environments (including non-production and production environments) and can pose significant security risks.

In addition, information related to scanning shared libraries for different code repositories and information related to vulnerability fixes needs to be manually tracked. Manually tracking such information is time-consuming and prone to error. Also, some vulnerabilities do not require code modifications. For example, updating a reference to a software component in a build file to a more recent version does not require modifying the source code. However, analyzing and resolving these types of vulnerabilities is currently a manual process.

One or more embodiments described herein can reduce the resources needed to maintain and execute such pipelines. In some embodiments, a pipeline can be executed on a given code repository, and identified vulnerabilities can be tracked and reported across one or more other code repositories without needing to execute the pipeline on each of the other code repositories. Such embodiments can help proactively identify and manage software vulnerabilities across multiple code repositories.

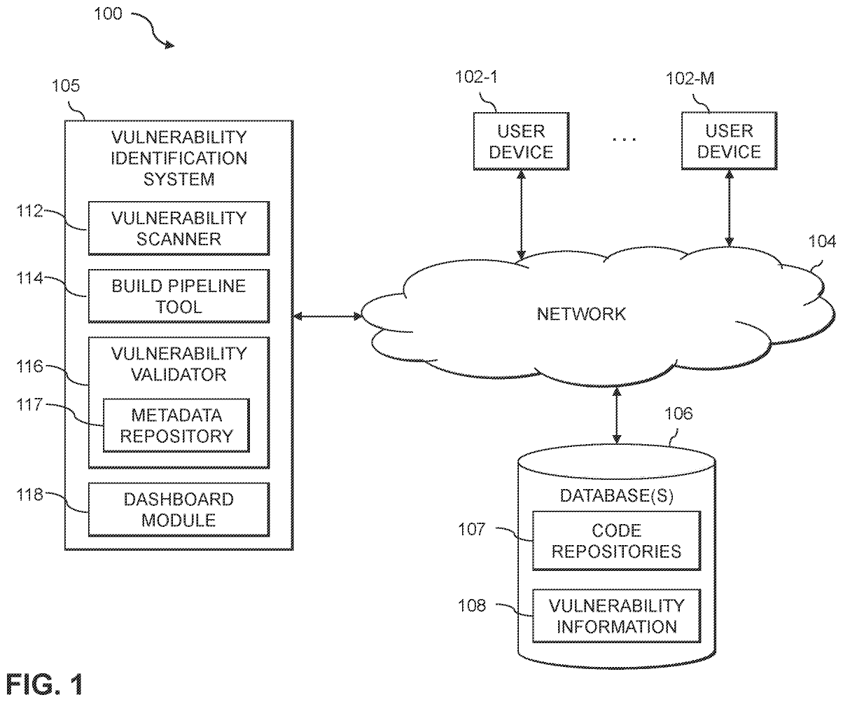

FIG. 1 shows a computer network (also referred to herein as an information processing system) 100 configured in accordance with an illustrative embodiment. The computer network 100 comprises a plurality of user devices 102-1, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is a vulnerability identification system 105.

The user devices 102 may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the vulnerability identification system 105 can have at least one associated database 106 configured to store data pertaining to, for example, a plurality of code repositories 107. The code repositories 107 can comprise, for example, software code corresponding to one or more software components. The term “software components” in this context and elsewhere herein is intended to be broadly construed so as to encompass, for example, software applications, software libraries, software services, software drivers, and/or other types of software entities configured to perform at least one particular function. According to some embodiments, the code repositories 107 can comprise source code that is maintained and/or utilized by a given organization. The at least one associated database 106 can also be configured to store data pertaining to vulnerability information 108, which can correspond to, or be obtained from, a global vulnerability database, such as an NVD.

Although the FIG. 1 example shows the code repositories 107 and the vulnerability information being implemented by the at least one database 106, it is to be appreciated that a variety of other arrangements are also possible. For example, at least portions of one or more of the code repositories 107 and/or the vulnerability information 108 may be stored across multiple distinct entities, such as multiple distinct databases, one or more of the user devices 102, the vulnerability identification system 105, and/or one or more other entities not explicitly shown in FIG. 1 (e.g., one or more code repository hosting platforms or tools).

An example database 106, such as depicted in the present embodiment, can be implemented using one or more storage systems associated with the vulnerability identification system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the vulnerability identification system 105 are one or more input-output devices, which illustratively comprise keyboards, displays or other types of input-output devices in any combination. Such input-output devices can be used, for example, to support one or more user interfaces to the vulnerability identification system 105, as well as to support communication between vulnerability identification system 105 and other related systems and devices not explicitly shown.

Additionally, the vulnerability identification system 105 in the FIG. 1 embodiment is assumed to be implemented using at least one processing device. Each such processing device generally comprises at least one processor and an associated memory, and implements one or more functional modules for controlling certain features of the vulnerability identification system 105.

More particularly, the vulnerability identification system 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the vulnerability identification system 105 to communicate over the network 104 with the user devices 102, and illustratively comprises one or more conventional transceivers.

The vulnerability identification system 105 further comprises at least one vulnerability scanner 112, at least one build pipeline tool 114, a vulnerability validator 116, and a dashboard module 118.

Generally, the at least one vulnerability scanner 112 can obtain vulnerability information 108 that is used to scan source code corresponding to a given one of the code repositories 107.

The build pipeline tool 114, in some embodiments, can synchronize external library dependencies and vulnerabilities identified for the given code repository with the vulnerability validator 116. For example, the build pipeline tool 114 can implement one or more plugin components that are executed during the build process of a given one of the code repositories 107.

The build pipeline tool 114, in some embodiments, can use the plugin components to perform the synchronization via one or more application programming interfaces (APIs). For example, a plugin component of the build pipeline tool 114 can obtain application metadata (e.g., application name, deployment environment, deployment timestamp, and/or a list of dependent libraries including version information and timestamp information related to the dependent libraries). The build pipeline tool 114 can also obtain scan information from the at least one vulnerability scanner 112. The application metadata and the information related to the scanned vulnerabilities can be sent to the vulnerability validator 116 for further processing.

The vulnerability validator 116, in some embodiments, can also maintain the received metadata in a metadata repository 117. In the FIG. 1 example, the metadata repository 117 is shown as part of the vulnerability validator 116, however, it is to be appreciated that other configurations are possible in different embodiments. For example, at least a portion of the metadata repository 117 can be implemented separately from the vulnerability validator 116, such as at least in part by one or more of the user devices 102, the at least one database 106, or as a separate entity in the computer network 100.

The metadata repository 117, or portions thereof, can be verified each time a build pipeline is executed to capture any incremental changes in the metadata. The vulnerability validator 116 can also be configured to analyze the information sent by the build pipeline tool 114 in order to identify vulnerabilities across the one or more code repositories 107. For example, the vulnerability validator 116 can use the metadata repository 117 and the vulnerability information to identify applications (e.g., associated with different one or more other code repositories 107) that might be impacted by the same reported and/or detected vulnerabilities.

According to some embodiments, the vulnerability validator 116 is further configured to perform one or more automated actions based on the analysis. For example, the vulnerability validator 116 can analyze the vulnerability information to determine a complexity of changes that are needed to remediate a reported vulnerability. If the vulnerability validator 116 determines that the reported vulnerability can be addressed automatically (e.g., without any manual intervention), then it can automatically implement such changes and, optionally, automatically initiate another execution build pipeline so that the software code can be rebuilt with the changes that were made. In some embodiments, the complexity can be based at least in part on whether or not changes are needed to the source code. For example, if the reported vulnerability corresponds to a dependent library version that needs to be updated, then a fix can be applied automatically by the vulnerability validator 116 since the source code does not need to be altered.

In response to determining that the changes are too complex (e.g., changes to the source code are required), then the vulnerability validator 116 can, in at least some embodiments, notify one or more users (e.g., associated with the user devices 102) of the vulnerability. As a non-limiting example, the notification can include information related to the vulnerability and possibly one or more steps and/or recommendations to address the vulnerability.

According to some embodiments, the vulnerability validator 116 can also generate one or more types of reports that can be used for planning purposes and/or to gauge the risk levels of the vulnerabilities. For example, the vulnerability validator 116 may generate a first type of report comprising a list of pending issues and possible fixes for a developer user, a second type of report comprising a list of issues categorized by risk level (e.g., critical, major, minor, etc.) for an executive user, and/or a third type of report comprising information related to one or more software libraries (e.g., a number of issues, one or more repeating issues, and/or a severity of at least one issues) for a DevOps user.

In at least one embodiment, when the vulnerability scanner 112 identifies a new vulnerability and/or when a known vulnerability is added to a global vulnerability database, the vulnerability validator 116 can analyze the changes that were performed to fix the vulnerability and recommend steps to fix the vulnerability. This allows, for example, the vulnerability validator 116 to determine if there are any known vulnerabilities and recommend fixes even before proceeding with new build and/or vulnerability scan processes.

According to some embodiments, the functionalities of the vulnerability validator 116 can be implemented using a set of microservices. For example, in one embodiment, the set of microservices may include a microservice for each of the following functionalities: fetching vulnerabilities, analyzing an impact of a vulnerability, managing metadata associated with the code repositories 107, implementing and committing fixes for vulnerabilities, and generating recommendations and reports.

The dashboard module 118 can be configured to output different views and/or data to be displayed to one or more users based on the type of user (e.g., developer users, DevOps users, and/or executive users). For instance, the dashboard module 118 can display the reports and/or notifications generated by the vulnerability validator.

It is to be appreciated that this particular arrangement of elements 112, 114, 116, 117 and 118 illustrated in the vulnerability identification system 105 of the FIG. 1 embodiment is presented by way of example only, and alternative arrangements can be used in other embodiments. For example, the functionality associated with the elements 112, 114, 116, 117, and 118 in other embodiments can be combined into a single element, or separated across a larger number of elements. As another example, multiple distinct processors can be used to implement different ones of the elements 112, 114, 116, 117, and 118 or portions thereof.

At least portions of elements 112, 114, 116, 117, and 118 may be implemented at least in part in the form of software that is stored in memory and executed by a processor.

It is to be understood that the particular set of elements shown in FIG. 1 for vulnerability identification system 105 involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the vulnerability identification system 105 and database(s) 106 can be on and/or part of the same processing platform.

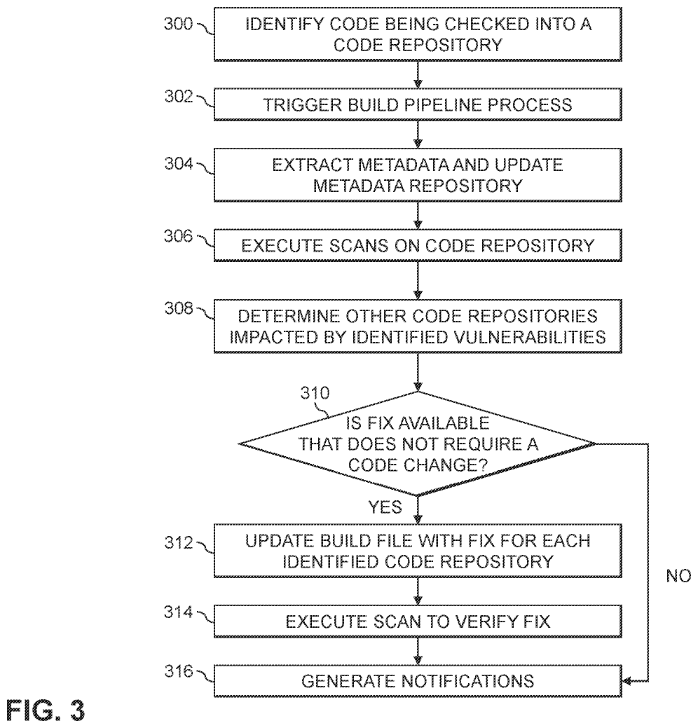

An exemplary process utilizing elements 112, 114, 116, 117, and 118 of an example vulnerability identification system 105 in computer network 100 will be described in more detail with reference to, for example, the flow diagrams of FIGS. 3-5.

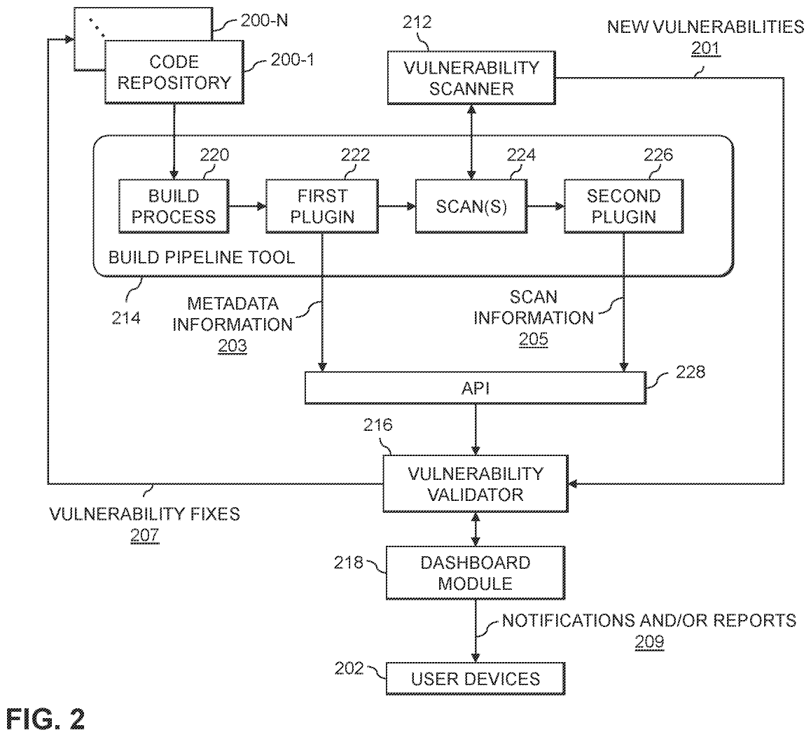

FIG. 2 shows an example of a system architecture in accordance with an illustrative embodiment. In the FIG. 2 example, the system architecture includes a plurality of code repositories 200-1, . . . 200-N (collectively, code repositories 200), at least one vulnerability scanner 212, a build pipeline tool 214, a vulnerability validator 216, and a dashboard module 218. According to some embodiments, the build pipeline tool 214 obtains source code corresponding to code repository 200-1, and then initiates a build process 220. The build pipeline tool 214 also includes a first plugin 222 that extracts metadata information 203 associated with the code repository 200-1. For example, the first plugin 222 can obtain one or more build configuration files corresponding to the code repository 200-1, and can extract at least some of the metadata information 203 from the build configuration files. Additionally or alternatively, at least a portion of the metadata can be obtained as a result of the build process. For example, in some instances the build process can expand the dependency information in the one or more build configuration files, and this expanded information can be used to obtain a list of dependencies (e.g., libraries). The metadata information 203 can then be sent to the vulnerability validator 216 via at least one API 228. In some examples, the build pipeline tool 214 can perform one or more scans 224 on source code of the code repository 200-1 using at least one vulnerability scanner 212. The resulting scan information 205 is collected by a second plugin 226 of the build pipeline tool 214, which then sends the scan information 205 to the vulnerability validator 216 via the at least one API 228. Although the build pipeline tool 214 in FIG. 2 is shown having two plugin components 222 and 226, it is to be appreciated that a single plugin component can be used in other embodiments.

The vulnerability validator 216, in some embodiments, stores the metadata information 203 in a metadata repository (such as metadata repository 117 in FIG. 1). It is noted that the vulnerability validator 216 can collect and update the metadata information for the code repository 200-1 each time a build process is performed. The vulnerability validator 216 can also maintain metadata information for at least some of the other code repositories 200.

In some embodiments, the vulnerability validator 216 identifies whether any vulnerabilities are present in the code repository 200-1 based at least in part on the scan information 205. In response to detecting a vulnerability, the vulnerability validator 216 can query the metadata repository to determine the impact of the vulnerability across the other code repositories 200. As a non-limiting example, if a vulnerability is detected in a particular library associated with the code repository 200-1, then the vulnerability validator 216 can query the metadata repository to determine if that particular library is used by one or more of the other code repositories 200. If so, then the one or more other code repositories 200 can be considered impacted by the vulnerability. In some embodiments, the impact can be based on additional information associated with the vulnerability (such as the type of vulnerability, the location of the vulnerability, and/or the severity of the vulnerability), types of deployment environments corresponding to the one or more other code repositories 200, and/or version information related to the particular library.

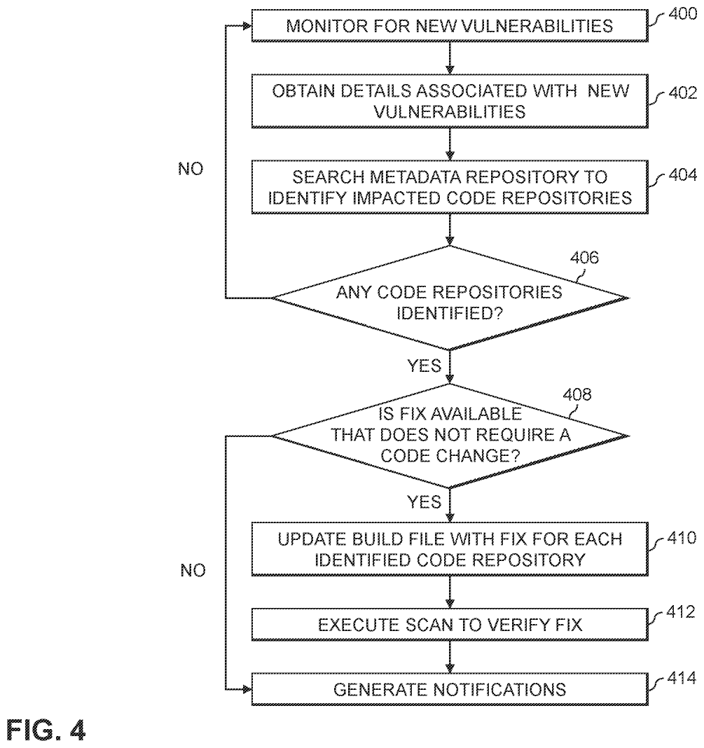

Also, in at least some embodiments, the vulnerability validator 216 can monitor for new vulnerabilities 201 that have been added to the vulnerability scanner 212. As an example, the vulnerability scanner 212 can be updated to include vulnerability information from a global vulnerability database. In some embodiments, the new vulnerabilities 201 can be pushed to the vulnerability validator 216 by the vulnerability scanner 212 and/or the vulnerability validator 216 can periodically check whether any new vulnerabilities 201 have been added to the vulnerability scanner. In response to identifying one or more new vulnerabilities 201, the vulnerability validator 216 can proactively determine the impact of new vulnerabilities 201 across the code repositories 200 based on the metadata repository, and possibly implement one or more vulnerability fixes 207 on the codes repositories 200 that are impacted. An example of a process for proactively identifying vulnerabilities is described in more detail in conjunction with FIG. 4, for example.

The dashboard module 218 can obtain data related to metadata and vulnerabilities from the vulnerability validator 216, and generate notifications and/or reports 209, which can be sent to (or obtained by) one or more user devices 202, as explained in more detail elsewhere herein.

Relative to conventional techniques, one or more embodiments allow some processes (e.g., related to vulnerability identification, impact analysis, tracking of the fixes, etc.) to be executed separately from processes and toolsets related to building and scanning source code. For example, metadata related to build details and dependencies for each of a plurality of code repositories can be retrieved and stored in a lightweight data repository (e.g., metadata repository 117). When a change is made to one or more build parameters or dependencies, the metadata in the data repository can be updated as part of the existing build pipeline. This type of information is often difficult and time consuming to obtain, often taking multiple days. At least some embodiments allow such information to be accurately identified almost instantaneously (e.g., seconds or less) as the data is available in a single data repository. This also allows the resolution statuses of vulnerabilities across the data repositories to be efficiently tracked.

FIG. 3 shows a flow diagram of a process for identifying vulnerabilities as part of a build process associated with a code repository in an illustrative embodiment. It is to be understood that this particular process is only an example, and additional or alternative processes can be carried out in other embodiments.

Step 300 includes identifying code being checked into a code repository, and step 302 includes triggering a build pipeline process.

Step 304 includes extracting metadata and updating a metadata repository. For example, the metadata may include extracting information related to one or more dependencies (e.g., libraries and/or other software code components) that are used by the code repository. The metadata may be extracted from one or more build configuration files, as explained in more detail elsewhere herein.

Step 306 includes executing one or more scans on the code repository. The one or more scans may be configured to identify vulnerabilities in source code associated with the code repository.

Step 308 includes determining other code repositories that are impacted by the identified vulnerabilities in step 306.

Step 310 includes a test to check whether a fix is available for at least one of the identified vulnerabilities that does not require a code change. If the result of step 310 is no, then the process continues directly to step 316 which includes notifying one or more code owners (and/or other interested parties) about the vulnerability. It is noted that the term “code owners” in this context and elsewhere herein is intended to be broadly construed so as to encompass, for example, one or more developers or one or more groups of developers that are responsible for maintaining, developing, testing, and/or triaging respective portions of the source code.

If the result of step 310 is yes, then step 312 is performed. Step 312 includes updating a build file for each of the identified codebases with the fix. Step 314 includes running one or more scans to verify that the fix has been implemented, and step 316 includes notifying the codebase owners about the vulnerability and/or the fix that was implemented.

FIG. 4 shows a flow diagram of a process for proactively identifying vulnerabilities in an illustrative embodiment. It is to be understood that this particular process is only an example, and additional or alternative processes can be carried out in other embodiments.

Step 400 includes monitoring for one or more new vulnerabilities. For example, the monitoring can include monitoring a global vulnerability database (e.g., an NVD) to identify if any new vulnerabilities have been added, or possibly monitoring for notifications sent by a vulnerability scanner (e.g., vulnerability scanner 212).

Step 402 includes obtaining details associated with the one or more new vulnerabilities. As a non-limiting example, the details can include a type of vulnerability, a location of the vulnerability, and/or a severity of the vulnerability.

Step 404 includes searching a metadata repository for impacted code repositories.

Step 406 includes a test to check whether any code repositories were found. If not, then the process returns to step 400. Otherwise, the process continues to step 408, which includes checking whether a fix is available for at least one of the identified vulnerabilities that does not require a code change. Steps 410-414 are performed in a similar manner as described with respect to steps 312-316 of FIG. 3.

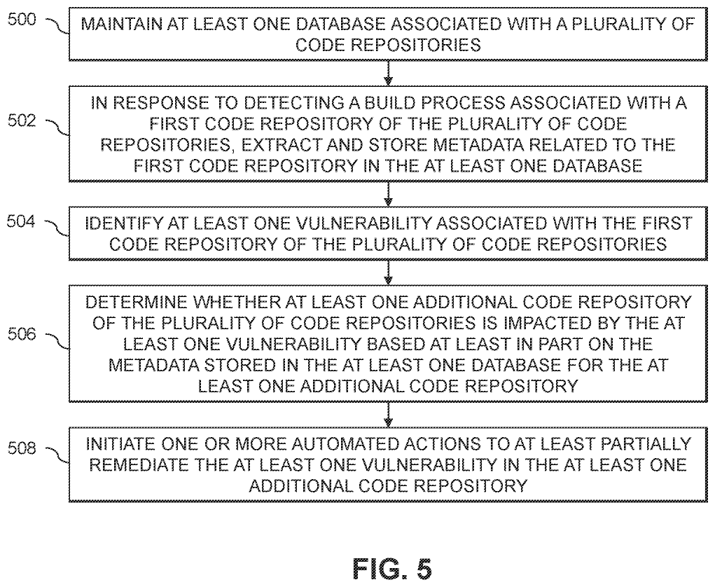

FIG. 5 is a flow diagram of a process for identifying vulnerabilities across software code repositories in an illustrative embodiment. It is to be understood that this particular process is only an example, and additional or alternative processes can be carried out in other embodiments.

In this embodiment, the process includes steps 500 through 508. These steps are assumed to be performed by the vulnerability identification system 105 utilizing its elements 112, 114, 116, and 118.

Step 500 includes maintaining at least one database associated with a plurality of code repositories. Step 502 includes, in response to detecting a build process associated with a first code repository of the plurality of code repositories, extracting and storing metadata related to the first code repository of a plurality of code repositories in the at least one database. Step 504 includes identifying at least one vulnerability associated with the first code repository of the plurality of code repositories. Step 506 includes determining whether at least one additional code repository of the plurality of code repositories is impacted by the at least one vulnerability based at least in part on the metadata stored in the at least one database for the at least one additional code repository. Step 508 includes initiating one or more automated actions to at least partially remediate the at least one vulnerability in the at least one additional code repository.

The identifying in step 504 may include scanning source code of the first code repository and/or detecting that the at least one vulnerability was added to a vulnerability database, such as an NVD.

The metadata related to a first code repository may correspond to at least one identifier of at least one software component associated with the first code repository, a set of dependent software components, one or more types of deployment environments, timestamp information, and version information (e.g., related to the at least one software component and/or the set of dependent software components).

At least a portion of the metadata related to the first code repository may be extracted based on a configuration file associated with the detected build process. Non-limiting examples of configuration files include a project object model (POM) file and a package.json file for Node projects.

The one or more automated actions may include updating a configuration file associated with the at least one additional code repository in response to determining that no changes to source code in the at least one additional code repository are needed to remediate the at least one vulnerability, and initiating a build process, associated with the at least one additional code repository, based at least in part on the updated configuration file. Updating the configuration file may include changing a version of a dependent software component that is referenced in the configuration file to a different version of the dependent software component to address the at least one vulnerability. The one or more automated actions may include sending a notification of the at least one vulnerability to one or more users associated with the at least one additional code repository. In some embodiments, the notification can include a risk level associated with the at least one vulnerability, one or more recommendations for remediating the at least one vulnerability, and/or one or more changes that were automatically performed to address the at least one vulnerability.

Accordingly, the particular processing operations and other functionality described in conjunction with the flow diagram of FIG. 5 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to significantly reduce the amount of time and resources needed to identify, track, and remediate vulnerabilities in software applications relative to conventional techniques. For example, some embodiments are configured to identify vulnerabilities in response to a build process being executed, and track and report such vulnerabilities across one or more other code repositories without needing to execute the pipeline on each of the other code repositories. Such embodiments can proactively identify and manage software vulnerabilities across multiple code repositories, and possibly automatically remediate at least a portion of the identified vulnerabilities.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

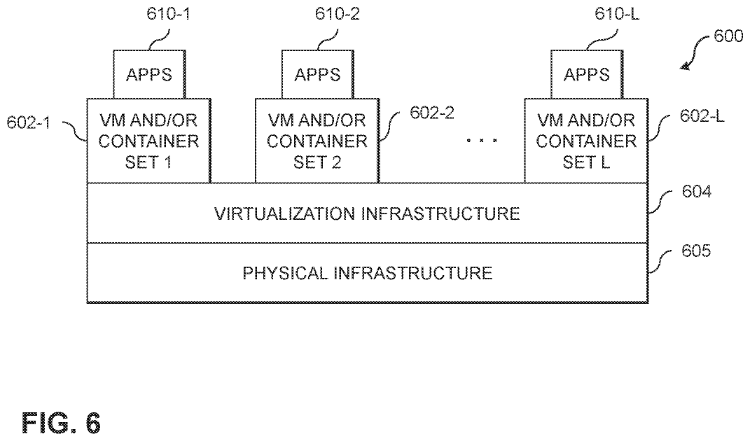

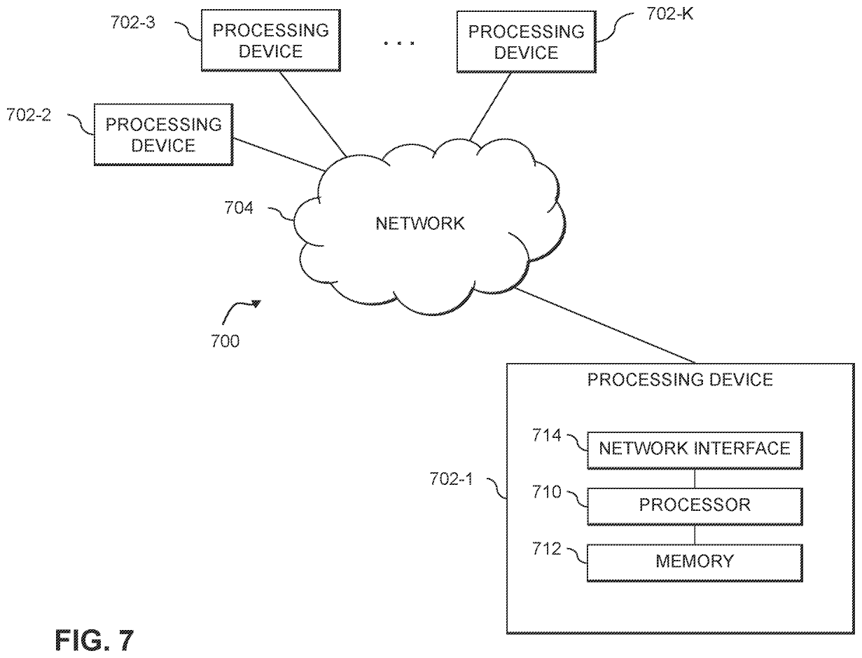

Illustrative embodiments of processing platforms will now be described in greater detail with reference to FIGS. 6 and 7. Although described in the context of system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that are utilized to implement at least a portion of the information processing system 100. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 comprise respective VMs, respective sets of one or more containers, or respective sets of one or more containers running in VMs. In some implementations of the FIG. 6 embodiment, the VMs/container sets 602 comprise respective VMs implemented using virtualization infrastructure 604 that comprises at least one hypervisor.

A hypervisor platform may be used to implement a hypervisor within the virtualization infrastructure 604, wherein the hypervisor platform has an associated virtual infrastructure management system. The underlying physical machines comprise one or more distributed processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of system 100 and includes a plurality of processing devices, denoted 702-1, 702-2, 702-3, . . . 702-K, which communicate with one another over a network 704.

The network 704 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 702-1 in the processing platform 700 comprises a processor 710 coupled to a memory 712.

The processor 710 comprises a microprocessor, a microcontroller, an ASIC, an FPGA or other type of processing circuitry, as well as portions or combinations of such circuitry elements.

The memory 712 comprises RAM, ROM or other types of memory, in any combination. The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
maintaining at least one database associated with a plurality of code repositories;
in response to detecting a build process associated with a first code repository of the plurality of code repositories, extracting and storing metadata related to the first code repository in the at least one database;
identifying at least one vulnerability associated with the first code repository of the plurality of code repositories;
determining whether at least one additional code repository of the plurality of code repositories is impacted by the at least one vulnerability based at least in part on the metadata stored in the at least one database for the at least one additional code repository; and
initiating one or more automated actions to at least partially remediate the at least one vulnerability in the at least one additional code repository;
wherein the method is performed by at least one processing device comprising a processor coupled to a memory.

2. The computer-implemented method of claim 1, wherein the identifying comprises at least one of:
scanning source code of the first code repository; and
detecting that the at least one vulnerability was added to a vulnerability database.

3. The computer-implemented method of claim 1, wherein the metadata related to the first code repository corresponds to at least one of:
at least one identifier of at least one software component associated with the first code repository;
a set of dependent software components;
one or more types of deployment environments;
timestamp information related to one or more of: the at least one software component and the set of dependent software components; and
version information related to one or more of: the at least one software component and the set of dependent software components.

4. The computer-implemented method of claim 1, wherein at least a portion of the metadata related to the first code repository is extracted based on a configuration file associated with the detected build process.

5. The computer-implemented method of claim 1, wherein the one or more automated actions comprise:
updating a configuration file associated with the at least one additional code repository in response to determining that no changes to source code in the at least one additional code repository are needed to remediate the at least one vulnerability; and
initiating a build process, associated with the at least one additional code repository, based at least in part on the updated configuration file.

6. The computer-implemented method of claim 5, wherein the updating the configuration file comprises:
changing a version of a dependent software component that is referenced in the configuration file to a different version of the dependent software component to address the at least one vulnerability.

7. The computer-implemented method of claim 1, wherein the one or more automated actions comprise:
sending a notification of the at least one vulnerability to one or more users associated with the at least one additional code repository, wherein the notification comprises at least one of: a risk level associated with the at least one vulnerability, one or more recommendations for remediating the at least one vulnerability, and one or more changes that were automatically performed to address the at least one vulnerability.

8. A non-transitory processor-readable storage medium having stored therein program code of one or more software programs, wherein the program code when executed by at least one processing device causes the at least one processing device:
to maintain at least one database associated with a plurality of code repositories;
in response to detecting a build process associated with a first code repository of the plurality of code repositories, to extract and store metadata related to the first code repository in the at least one database;
to identify at least one vulnerability associated with the first code repository of the plurality of code repositories;
to determine whether at least one additional code repository of the plurality of code repositories is impacted by the at least one vulnerability based at least in part on the metadata stored in the at least one database for the at least one additional code repository; and
to initiate one or more automated actions to at least partially remediate the at least one vulnerability in the at least one additional code repository.

9. The non-transitory processor-readable storage medium of claim 8, wherein the identifying comprises at least one of:
scanning source code of the first code repository; and
detecting that the at least one vulnerability was added to a vulnerability database.

10. The non-transitory processor-readable storage medium of claim 8, wherein the metadata related to the first code repository corresponds to at least one of:
at least one identifier of at least one software component associated with the first code repository;
a set of dependent software components;
one or more types of deployment environments;
timestamp information related to one or more of: the at least one software component and the set of dependent software components; and
version information related to one or more of: the at least one software component and the set of dependent software components.

11. The non-transitory processor-readable storage medium of claim 8, wherein at least a portion of the metadata related to the first code repository is extracted based on a configuration file associated with the detected build process.

12. The non-transitory processor-readable storage medium of claim 8, wherein the one or more automated actions comprise:
updating a configuration file associated with the at least one additional code repository in response to determining that no changes to source code in the at least one additional code repository are needed to remediate the at least one vulnerability; and
initiating a build process, associated with the at least one additional code repository, based at least in part on the updated configuration file.

13. The non-transitory processor-readable storage medium of claim 12, wherein the updating the configuration file comprises:
changing a version of a dependent software component that is referenced in the configuration file to a different version of the dependent software component to address the at least one vulnerability.

14. The non-transitory processor-readable storage medium of claim 8, wherein the one or more automated actions comprise:
sending a notification of the at least one vulnerability to one or more users associated with the at least one additional code repository, wherein the notification comprises at least one of: a risk level associated with the at least one vulnerability, one or more recommendations for remediating the at least one vulnerability, and one or more changes that were automatically performed to address the at least one vulnerability.

15. An apparatus comprising:
at least one processing device comprising a processor coupled to a memory;
the at least one processing device being configured:
to maintain at least one database associated with a plurality of code repositories;
in response to detecting a build process associated with a first code repository of the plurality of code repositories, to extract and store metadata related to the first code repository in the at least one database;
to identify at least one vulnerability associated with the first code repository of the plurality of code repositories;
to determine whether at least one additional code repository of the plurality of code repositories is impacted by the at least one vulnerability based at least in part on the metadata stored in the at least one database for the at least one additional code repository; and
to initiate one or more automated actions to at least partially remediate the at least one vulnerability in the at least one additional code repository.

16. The apparatus of claim 15, wherein the identifying comprises at least one of:
scanning source code of the first code repository; and
detecting that the at least one vulnerability was added to a vulnerability database.

17. The apparatus of claim 15, wherein the metadata related to the first code repository corresponds to at least one of:
at least one identifier of at least one software component associated with the first code repository;
a set of dependent software components;
one or more types of deployment environments;
timestamp information related to one or more of: the at least one software component and the set of dependent software components; and
version information related to one or more of: the at least one software component and the set of dependent software components.

18. The apparatus of claim 15, wherein at least a portion of the metadata related to the first code repository is extracted based on a configuration file associated with the detected build process.

19. The apparatus of claim 15, wherein the one or more automated actions comprise:
updating a configuration file associated with the at least one additional code repository in response to determining that no changes to source code in the at least one additional code repository are needed to remediate the at least one vulnerability; and
initiating a build process, associated with the at least one additional code repository, based at least in part on the updated configuration file.

20. The apparatus of claim 19, wherein the updating the configuration file comprises:
changing a version of a dependent software component that is referenced in the configuration file to a different version of the dependent software component to address the at least one vulnerability.
